(19) United States
(12) Patent Application Publication
(10) Pub. No.: US 2024/0154257 A1
(43) Pub. Date: May 9, 2024

(54) Cell Level Fusible Link for a Lithium Ion Battery

(71) Applicant: Textron Aviation Inc., Wichita, KS (US)

(72) Inventor: Michael Louis Koonce, Wichita, KS (US)

(21) Appl. No.: 18/502,204

(22) Filed: Nov. 6, 2023

Related U.S. Application Data
(60) Provisional application No. 63/382,820, filed on Nov. 8, 2022.

(51) Int. Cl. H01M 50/516; H01M 10/0525; H01M 50/534; H01M 50/581

(52) U.S. Cl. CPC H01M 50/516; H01M 10/0525; H01M 50/534; H01M 50/581

(57) ABSTRACT

A battery system includes a first battery cell; a second battery cell positioned adjacent to the first battery cell; and a fusible link connecting the first battery cell to the second battery cell. The fusible link having a first tab connected to and extending from the first battery cell; a second tab connected to and extending from the second battery cell; and a connection connecting the first tab to the second tab; the connection is to release the first tab from the second tab upon being heated to a threshold temperature; and releasing the first tab from the second tab protects the first battery cell from thermal runaway conditions of the second cell.

### CROSS-REFERENCE TO RELATED APPLICATIONS

This application claims the benefit of priority of U.S. Provisional Patent Application No. 63/382,820, entitled Cell Level Fusible Link for a Lithium Ion Battery, filed on Nov. 8, 2022, the disclosure of which is herein incorporated by reference in its entirety.

### BACKGROUND

### 1. Field

Embodiments of the disclosure relate to battery systems, and in particular to a cell level fusible link for a lithium-ion battery.

### 2. Related Art

Fusible links are known in the prior art. For example, U.S. Pat. No. 6,249,063 to Rudoy et al. discloses use of a frangible actuator and switch that are configured to switch an electrical circuit when the current through a fusible link exceeds a predetermined value, thereby isolating a defective cell in a battery. U.S. Pat. No. 5,227,259 to Weaver et al. discloses a method for locating and electrically isolating a failed cell in a network of cells by using a device for sampling voltage and current levels of the cells of a battery, and another device to compare the sampled voltage and current levels to voltage and current limits to determine if the cell has failed. Upon detection of a failed cell, an activation signal is conveyed to a heating element to in turn melt a fusible link, thereby isolating the failed cell. U.S. Pat. No. 7,158,041 to McDonald et al. discloses a fusible link that becomes open when an excessive current or voltage is applied.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

An embodiment of the present invention relates to a fusible link for connecting a first battery cell to a second battery cell, the fusible link comprising a first tab configured to connect to and extend away from the first battery cell; a second tab configured to connect to and extend away from the second battery cell; and a connection connecting the first tab to the second tab; wherein the connection is configured to release the first tab from the second tab upon being heated to a threshold temperature; and wherein releasing the first tab from the second tab protects the first battery cell from thermal runaway conditions of the second cell.

Another embodiment of the present invention relates to a battery system, comprising a first battery cell; a second battery cell positioned adjacent to the first battery cell; and a fusible link connecting the first battery cell to the second battery cell. The fusible link having a first tab connected to and extending from the first battery cell; a second tab connected to and extending from the second battery cell; and a connection connecting the first tab to the second tab. The connection is configured to release the first tab from the second tab upon being heated to a threshold temperature; and releasing the first tab from the second tab protects the first battery cell from thermal runaway conditions of the second cell.

Another embodiment of the present invention relates to a method of protecting a plurality of battery cells within a battery from entering into thermal runaways, the method comprising connecting a first tab to a first battery cell of the battery; connecting a second tab to a second battery cell of the battery; connecting the first tab to the second tab with a connection; releasing heated gas from the second battery cell as the second battery cell enters a thermal runaway such that the connection is exposed to the heated gas; and disconnecting the first tab from the second tab when the connection reaches a threshold temperature, the threshold temperature causing the connection to release, wherein the first battery cell is protected from entering into a second thermal runaway due to the disconnecting of the first tab from the second tab.

### BRIEF DESCRIPTION OF THE DRAWING FIGURES

Embodiments of the invention are described in detail below with reference to the attached drawing figures, wherein:

FIG. 1A depicts a series of events associated with a conventional battery system with a thermal runaway in one cell leading to propagation;

FIG. 1B depicts a series of events associated with a battery system with a fusible link in accordance with the present invention, wherein propagation is prevented in the event of a thermal runaway in one cell;

FIG. 2A shows a battery system with a fusible link of the present invention with a connection intact;

FIG. 2B shows the battery system of FIG. 2A with the fusible link of the present invention with the connection released; and

FIG. 3 is a block diagram of a battery system utilizing the fusible link of the present invention.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Batteries are a common device for the storage of energy for use in a variety of industries and may vary from providing small energy storage levels to large energy storage levels. As the energy levels increase, the battery will increase in a number of cells within the battery, the cells being the storage units of energy. Lithium-ion batteries are common, particularly for use with aircraft, and use lithium ions as a component of electrochemistry for power storage.

Thermal runaways are a potentially devastating problem that can occur with batteries. A thermal runaway may begin when one cell in a plurality of cells is damaged or otherwise malfunctions. This can occur when the cell is physically damaged, damaged from overcharging/over-discharging, is kept outside of a safe temperature range, or through other causes. In a thermal runaway situation, when the cell malfunctions, its temperature can begin to rise. This rise in temperature can change the conditions within the cell in a way that causes a further increase in temperature and pressure, and even further a release of flammable gases, resulting in a fire hazard.

Cells in a battery are generally connected into a network either in a series or in parallel and when a thermal runaway occurs in one cell, neighboring cells may be affected. For example, a failed cell may create a short circuit and drain the capacity of neighboring cells. Further, when one cell enters into a thermal runaway, connected cells may subsequently heat up and enter into their own thermal runaway, resulting then in propagation of a plurality of cells in a network.

Failure of a cell within a network of cells is generally unpredictable and random, and therefore any solution must anticipate failure and provide a solution immediately and at any cell within the network.

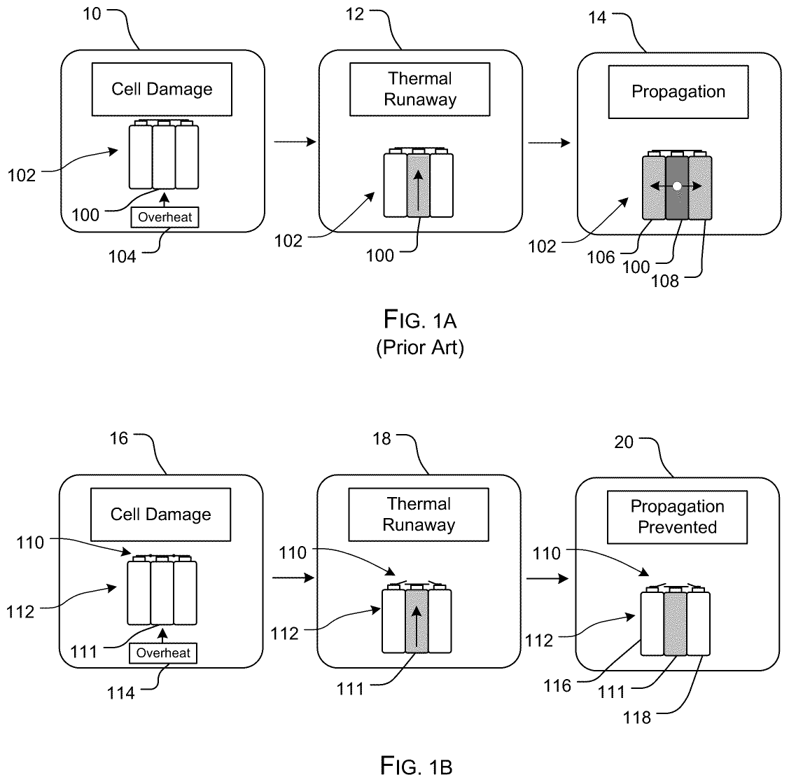

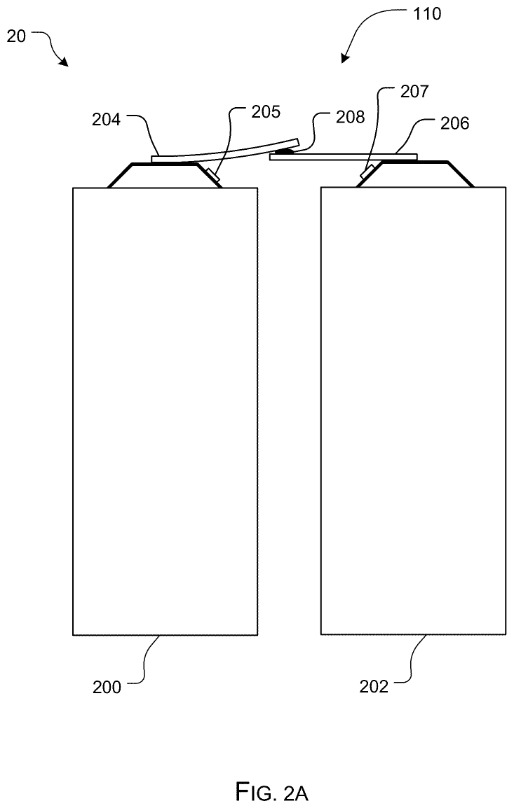

FIG. 1A shows an exemplary series of events that may conventionally occur with a thermal runaway and result in propagation of a battery. As shown, in a first event 10, one cell 100 of a plurality of cells 102 begins to overheat 104 due to a malfunction. This malfunction may also occur based on physical damage, damage from overcharging/over-discharging, temperatures outside of a suitable range, or other causes. As shown in the second event 12, the cell 100 enters thermal runaway, wherein the temperature and pressure rise rapidly, leading to propagation to neighboring cells 106, 108 of the plurality of cells 102, as shown in event 14. Accordingly, the result of the events shown in FIG. 1A is a plurality of cells being damaged and unusable. In addition, the result of propagation can lead to dangerous and unpredictable conditions.

FIG. 1B shows a simplified series of events associated with use of a fusible link 110 in accordance with the present invention. In this series, the first event 16 again includes one cell 111 of a plurality of cells 112 overheating 114 due to any reason, such as a malfunction, physical damage, damage from overcharging/over-discharging, temperatures outside of a suitable range, or other causes. The overheating 114 leads to a thermal runaway in cell 111, as shown in event 18. In the present invention, the fusible link 110 is configured to disconnect cell 111 from neighboring cells 116, 118 in the event of a thermal runaway, thereby preventing propagation, as shown in event 20. In the present invention, the fusible link 110 is configured to disconnect, as will be discussed in more detail herein, upon being heated above a threshold, thereby allowing for disconnection when hot gasses are released from the cell 111 that has entered into a thermal runaway. FIGS. 1A and 1B show an embodiment of a plurality of battery cells electrically connected in series; however, a plurality of battery cells electrically connected in parallel would operate similarly with the outer cells 106, 108 in FIG. 1A and outer cells 116, 118 in FIG. 1B flipped 180-degrees and fusible link 110 remaining at the top of the plurality of cells 102, 112.

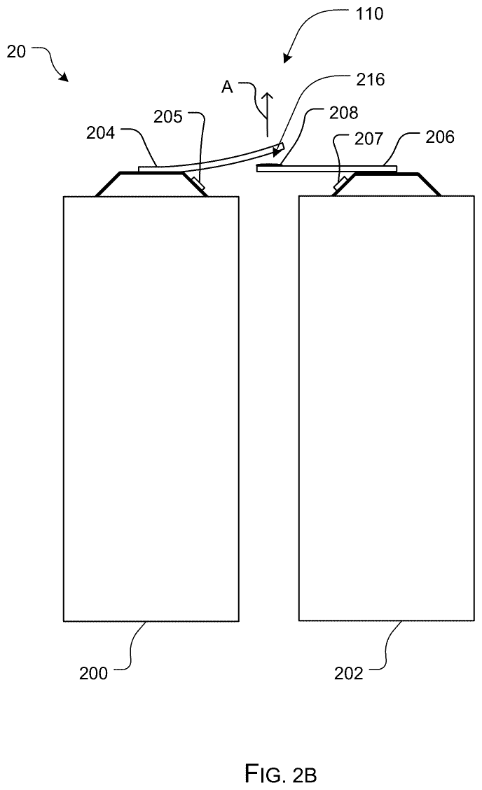

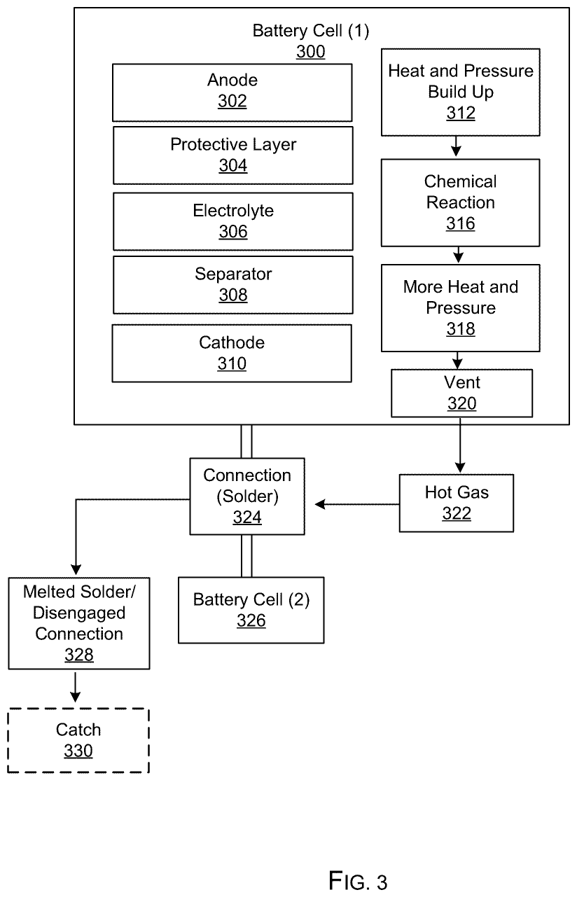

In FIGS. 2A and 2B, a battery system 20 is shown having the fusible link 110 in accordance with the present invention. As shown, the fusible link 110 extends between a first cell 200 and a second cell 202 of the battery system 20, the first cell 200 and the second cell 202 being adjacent to one another, adjacent meaning near to, regardless of physical contact between the two cells. The fusible link 110 includes a first tab 204 connected to the first cell 200, a second tab 206 connected to the second cell 202, and a connection 208 between the first tab 204 and the second tab 206, thereby completing a circuit and allowing for operation of the battery.

The connection 208 is designed to release the first tab 204 from the second tab 206 upon being heated beyond a predetermined temperature. The heating of the connection 208 will occur in the event of a thermal runaway of one of the cells 200, 202, wherein heat may be released from a vent 205, 207 of the associated cell that has entered into the thermal runaway. This allows for a physical disconnect of the cells 200, 202, thereby isolating the damaged cell and protecting the neighboring cells.

In at least some embodiments of the present invention, the connection 208 is a solder connecting the first tab 204 to the second tab 206. The solder can be heat dependent based on the industry and application of the battery system. For example, a material used in the solder can vary as would be needed to withstand a temperature up to a pre-selected threshold temperature, the pre-selected threshold temperature being selected by those skilled in the art depending on the chemistry of the battery, thereby ensuring that the solder would melt and disconnect at the appropriate and desired temperature. In other words, the material and/or size of the connection 208 can be selected based on first determining the desired pre-selected threshold temperature.

The tabs 204, 206 can be composed of a metal and can also vary as would be understood by those skilled in the art. For example, it is contemplated that in at least some embodiments, at least one of the tabs 204, 206 would be a sprung tab, such that tension is constantly applied to connection 208. This will allow for the sprung tab 204 to spring-release from the second tab 206 and create a gap 216 once the connection 208 melts and releases tab 204, as shown with arrow A. In alternative embodiments, the tabs 204, 206 may be bimetallic such that one or both tabs 204, 206 may curl, again shown with arrow A, and release from the second tab 206 based on differing metals. In other words, one or both tabs 204, 206 may independently be composed of at least two metals, wherein the at least two metals have different expansion rates such that the one or both tabs will curl when heated to the threshold temperature such that tabs release from one another.

In FIG. 3, a block diagram depicts the functional operation associated with the battery system of the present invention. As shown, a first battery cell 300 will include components known in the art, which may include, among others, an anode 302, a protective layer 304, an electrolyte 306, a separator 308, and a cathode 310. Inside of the first battery cell 300, when a failure occurs, heat and pressure begin to build up 312, causing the protective layer 304 to break down and the electrolyte 306 to further break down into flammable gases. This can then lead to the separator 308 melting and the cathode 310 breaking down and generating oxygen. This combination of chemical reactions 316 causes more heat and pressure to build 318 which are eventually expelled through a vent 320 of the first battery cell 300.

As hot gas 322 is expelled from the vent 320, it acts upon a connection 324 between the first battery cell 300 and a second battery cell 326. The connection 324, which may be a solder, will melt and disengage the battery cells 300, 326, thereby protecting the second battery cell 326 and isolating the first battery cell 300. It is contemplated that in at least some embodiments, a catch 330 may be provided to collect the melted solder 328.

It should be appreciated that one of the unique features believed characteristic of the present invention is the fusible link, which will physically disconnect a cell that has entered into a thermal runaway and protect remaining cells to allow for continued use of at least some of the battery and protect against potentially damaging and dangerous conditions. The disconnect of the fusible link is independent of current for activation, which provides for improved reliability. The ability for at least some of the battery to continue operation is particularly beneficial for aircraft, wherein a total failure results in an immediate need to land, as opposed to a need to land as soon as practicable. Further, the use of a solder connection provides for minimal additional weight to the battery.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A fusible link for connecting a first battery cell to a second battery cell, the fusible link comprising:
a first tab configured to connect to and extend away from the first battery cell;
a second tab configured to connect to and extend away from the second battery cell; and
a connection connecting the first tab to the second tab;
wherein the connection is configured to release the first tab from the second tab upon being heated to a threshold temperature; and
wherein releasing the first tab from the second tab protects the first battery cell from thermal runaway conditions of the second cell.

2. The fusible link of claim 1, wherein the first tab and the second tab are composed of metal.

3. The fusible link of claim 2, wherein the connection is a solder connecting the first tab and the second tab.

4. The fusible link of claim 1, wherein the first tab is composed of at least a first metal and a second metal, the first metal and the second metal each having different expansion rates such that the first tab is configured to curl when heated to the threshold temperature such that the first tab releases from the second tab.

5. The fusible link of claim 1, wherein the first tab is a sprung tab configured to spring-release away from the second tab when released therefrom.

6. A battery system, comprising:
a first battery cell;
a second battery cell positioned adjacent to the first battery cell; and
a fusible link connecting the first battery cell to the second battery cell, the fusible link having:
a first tab connected to and extending from the first battery cell;
a second tab connected to and extending from the second battery cell; and a connection connecting the first tab to the second tab;
wherein the connection is configured to release the first tab from the second tab upon being heated to a threshold temperature; and
wherein releasing the first tab from the second tab protects the first battery cell from thermal runaway conditions of the second cell.

7. The battery system of claim 6, wherein the first battery cell and the second battery cell are lithium-ion battery cells.

8. The battery system of claim 6, wherein the first tab and the second tab are composed of metal.

9. The battery system of claim 7, wherein the connection is a solder connecting the first tab and the second tab.

10. The battery system of claim 6, wherein the first tab is composed of at least a first metal and a second metal, the first metal and the second metal each having different expansion rates such that the first tab is configured to curl when heated to the threshold temperature such that the first tab releases from the second tab.

11. The battery system of claim 6, wherein the first tab is a sprung tab configured to spring-release away from the second tab when released therefrom.

12. The battery system of claim 6, wherein the first battery cell further comprises a vent configured to release gas therefrom, wherein the gas causes the connection to heat above the threshold temperature.

13. A method of protecting a plurality of battery cells within a battery from entering into thermal runaways, the method comprising:
connecting a first tab to a first battery cell of the battery;
connecting a second tab to a second battery cell of the battery;
connecting the first tab to the second tab with a connection;
releasing heated gas from the second battery cell as the second battery cell enters a thermal runaway such that the connection is exposed to the heated gas; and
disconnecting the first tab from the second tab when the connection reaches a threshold temperature, the threshold temperature causing the connection to release;
wherein the first battery cell is protected from entering into a second thermal runaway due to the disconnecting of the first tab from the second tab.

14. The method of claim 13, wherein the battery is a lithium-ion battery.

15. The method of claim 13, further comprising creating a gap between the first tab and the second tab at a location of the connection after the threshold temperature causes the connection to release the first tab from the second tab.

16. The method of claim 15, wherein the gap is created by the first tab being a sprung tab such that tension causes the first tab to spring-release away from the second tab upon release.

17. The method of claim 15, wherein the gap is created due to the first tab being composed of at least a first metal and a second metal, the first metal and the second metal each having different expansion rates such that the first tab is configured to curl when heated to the threshold temperature such that the first tab releases from the second tab to create the gap.

18. The method of claim 15, wherein connecting the first tab to the second tab with a connection further comprises:
selecting a material based on the threshold temperature; and
creating a solder with the material between the first tab and the second tab;
wherein the solder is configured to melt once the material reaches the threshold temperature.
